(19) United States
(12) Patent Application Publication
(10) Pub. No.: US 2003/0079672 A1
(43) Pub. Date: May 1, 2003

(54) Instrument panel pointer

(76) Inventors: Sergei Kalashnikov, West Bloomfield, MI (US); Michael J. Luettgen, Bloomfield Hills, MI (US); Charles F. Weber, South Lyon, MI (US)

Correspondence Address: BRINKS HOFER GILSON & LIONE, P.O. BOX 10395, CHICAGO, IL, 60611, US

(21) Appl. No.: 10/003,986

(22) Filed: Oct. 31, 2001

(51) Int. Cl. G01D 11/28

(52) U.S. Cl. 116/288

(57) ABSTRACT

A high efficiency, high brightness instrument pointer illuminating apparatus includes a gage motor with a gage motor shaft extending therefrom, an instrument pointer mounted on the gage motor shaft and a plurality of light sources positioned radially around the gage motor shaft to supply light upward into the instrument pointer, wherein the instrument pointer includes a needle portion and a light reflecting portion that is flared outward from the needle portion and has a first reflective surface presenting an internally reflective surface adapted to reflect light received from the light sources outward into the needle portion at any angular position of the needle portion.

### TECHNICAL FIELD OF THE INVENTION

The present invention generally relates to an illumination device for the instrument pointer of a vehicle instrument panel.

### BACKGROUND OF THE INVENTION

Instrument pointers are used in automobiles to indicate to a driver of the vehicle certain vehicle conditions. When lighting conditions are poor, an instrument pointer must be illuminated to allow the driver of the vehicle to see the instrument pointer. Devices for providing illumination to the instrument pointer of a vehicle instrument panel are typically limited in that the brightness of the illumination is a factor of the size of the light bulb or other device that is providing the light. Therefore, there is a need in the industry for an improved instrument pointer illumination device with improved brightness characteristics.

### BRIEF DESCRIPTION OF THE DRAWINGS

FIG. 1 is a side sectional view of a first preferred embodiment of the present invention;

FIG. 2 is a top view of the first preferred embodiment;

FIG. 3 is a side sectional view of a second preferred embodiment of the present invention;

FIG. 4 is a side sectional view of a third preferred embodiment of the present invention;

FIG. 5 is a top view of the third preferred embodiment;

FIG. 6 is a side sectional view of a fourth preferred embodiment of the present invention; and

FIG. 7 is a top view of the fourth preferred embodiment.

### DETAILED DESCRIPTION FOR THE PREFERRED EMBODIMENTS

The following description of the preferred embodiments of the invention is not intended to limit the scope of the invention to these preferred embodiments, but rather to enable any person skilled in the art to make and use the invention.

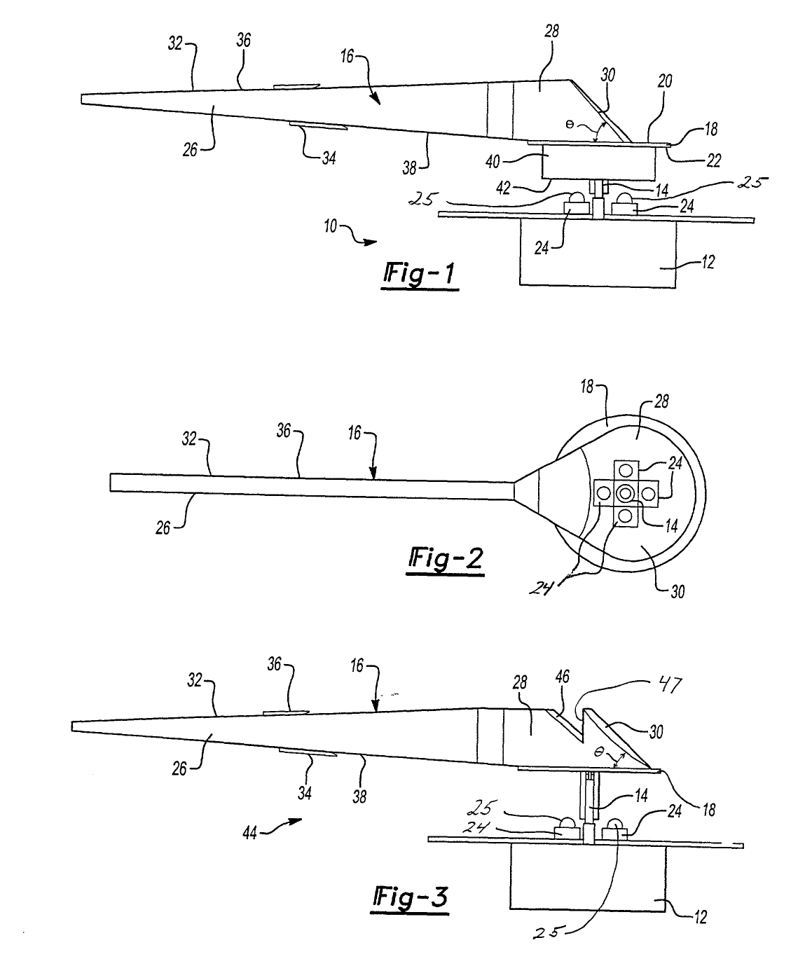

Referring to FIG. 1, a first preferred embodiment of an instrument pointer illuminating apparatus of the present invention is shown generally at 10. The first embodiment 10 includes a gage motor 12 with a gage motor shaft 14 extending upward therefrom. The gage motor 12 is adapted to provide rotational drive to the gage motor shaft 14. An instrument pointer 16 is mounted on the gage motor shaft 14. As shown, the instrument pointer 16 is mounted onto a hub 18. The hub 18 includes a top surface 20 and a bottom surface 22, wherein the instrument pointer is mounted onto the top surface 20 of the hub 18. Alternatively, it is to be understood, that the invention could be practiced without the hub 18, wherein the instrument pointer 16 is mounted directly to the gage motor shaft 14.

The first embodiment 10 further includes a plurality of light sources 24 to provide light to the instrument pointer 16. The light sources 24 are positioned radially around the gage motor shaft 14 and are adapted to supply light upward into the instrument pointer 16. The light sources 24 can be of any type suitable for the particular application, however, the light sources 24 are preferably light emitting diodes, or LED light sources. Additionally, the light sources 24 may each include a lens 25 to focus the light produced. The use of an optional lens 25 mounted onto the light sources 24 will help focus the light straight upward so that substantially all of the light will be received within the instrument pointer 16. It is to be understood that the invention can be practiced without the lenses 25, with less efficiency due to losses of light that escapes to the sides of the instrument pointer 16.

Referring to FIG. 2, the first preferred embodiment 10 has four light sources 24 spaced radially around the gage motor shaft 14 to provide light upward into the instrument pointer 16. It is to be understood, that the present invention can be practiced with as many light sources 24 as are required to achieve the brightness characteristics desired. The only limitation to the number of light sources 24 that can be used is the size of the instrument pointer 16, and the corresponding amount of space surrounding the gage motor shaft 14. A larger instrument pointer 16 would provide a larger space into which light sources 24 could be mounted. Additionally, using smaller light sources 24 would allow a higher number of light sources 24 to fit within the given space surrounding the gage motor shaft 14.

Preferably, the instrument pointer 16 is adapted to provide a visual indication of a vehicle condition such as speed or temperature, wherein the gage motor 12 is controlled by sensors within a vehicle and rotates the instrument pointer 16 relative to a fixed position dial on the instrument panel of the vehicle. The instrument pointer 16 includes a needle portion 26 and a light collecting portion 28. The light collecting portion 28 includes a first reflective surface 30 which is adapted to reflect light received from the light sources 24 outward into the needle portion 26 to illuminate the needle portion 26.

Preferably, the needle portion 26 includes a top surface 32 and a bottom surface 34. The top surface is preferably coated with a top diffusing material 36 which is adapted to diffuse a majority of the light outward through the top surface 32 and a smaller portion of the light back into the needle portion 26 where that portion of the light is reflected further outward into the needle portion 26, thereby illuminating the needle portion 26. The bottom surface 34 is coated with a material 38 which is adapted to internally reflect and diffuse within the needle portion 26 any light which hits the bottom surface 34, thereby preventing leakage of light downward onto the instrument panel, and illuminating the needle potion 26.

Preferably, the light collection portion 28 of the instrument pointer 16 is flared outward from the needle portion 26 across the hub 18, and the first reflective surface 30 presents an internally reflective polynomial concentrating surface. Preferably, light from the light sources 24 comes into the light collecting portion 28 of the instrument pointer 16 from below the instrument pointer 16. The first reflective surface 30 is at an angle θ such that the light from the light sources 24 is reflected from the first reflective surface 30 outward into the needle portion 26. Additionally, the polynomial shape of the first reflective surface 30 reflects light collected over the entire flared light collecting portion 28 and concentrates the light into the needle portion 26.

The flared shape of the light collecting portion 28 of the instrument pointer 16 provides a large surface area so that an optimum amount of light can be collected. Preferably, the light collection portion 28 of the instrument pointer 16 will cover substantially all of the hub 18. Preferably, the first embodiment 10 includes a light guide 40 mounted to the bottom 22 of the hub 18. The light guide 40 is a piece of clear material that is adapted to keep the light directed straight upward into the light collecting portion 28 of the instrument pointer 16. In the first preferred embodiment 10, a bottom surface 42 of the light guide 40 is in close proximity to the light sources 24 such that substantially all of the light produced by the light sources 24 is directed upward within the light guide 40. Preferably, the flared light collecting portion 28 of the instrument pointer 16 substantially covers all of the light guide 40 and hub 18 in order to capture substantially all of the light directed upward through the light guide 40, thereby allowing substantially all of the light to be collected regardless of the angular position of the needle portion 26. It is to be understood, that the invention can be practiced without the light guide 40 with slightly less efficient light collecting capability.

Referring to FIG. 3, a second preferred embodiment 44 of the present invention includes a second reflective surface 46 which is also adapted to reflect light received by the light collection portion 28 outward into the needle portion 26. The second reflective surface 46 also presents an internally reflective polynomial concentrating surface. Some of the light reflected from the first reflective surface 30 will travel through a clear notch portion 47 of the light collection portion 28. The notch portion 47 will cause the light to bend slightly due to refraction, therefore, the second reflective surface 46 is not exactly parallel to the first reflective surface 30. Preferably, the angle of the second reflective surface 46 is matched to the first reflective surface 30 and the notch portion 47 to compensate for the refraction of the light passing through the notch portion 47. Therefore, the light incident upon either of the first or second reflective surfaces 30, 46 is reflected outward into the needle portion 26.

The second reflective surface 46 allows light to be collected over a larger area without increasing the height of the instrument pointer 16. Since the angle θ of the first reflective surface 30 of the first preferred embodiment 10 is fixed, an instrument pointer 16 with a larger light collection portion 28 will have a correspondingly higher profile because as the area covered by the light collection portion 28 increases in the horizontal plane, the height of the light collection portion 28 increases in the vertical plane along the fixed angle θ. The use of the first and second reflective surfaces 30, 46 in line with each other allows more horizontal surface area to be covered without increasing the overall height of the instrument pointer 16. Additionally, it is to be understood that the present invention could be practiced with more than two reflective surfaces.

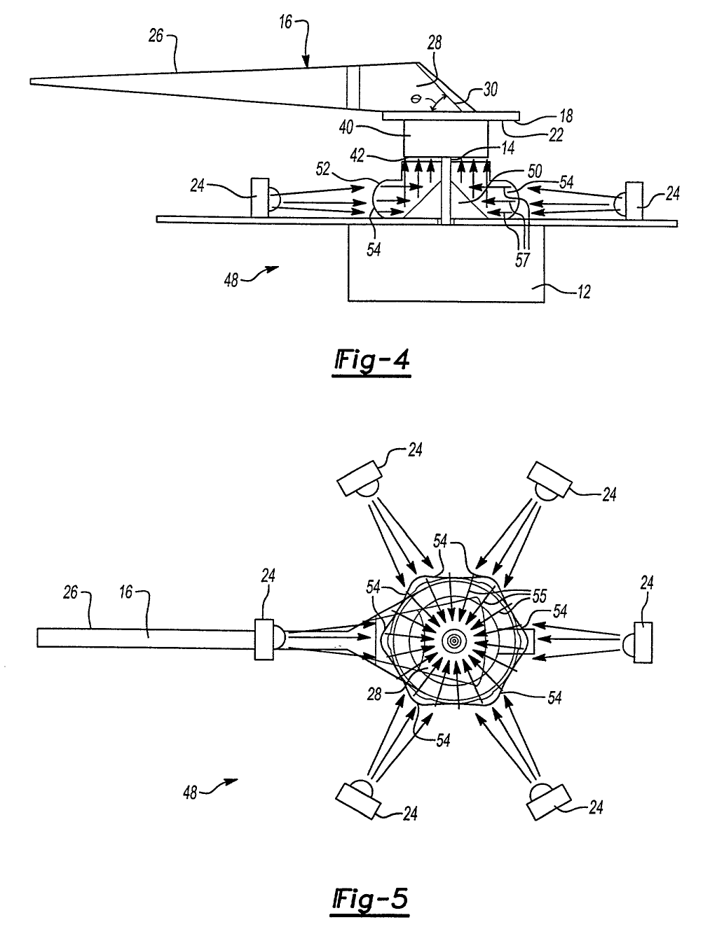

Referring to FIG. 4, a third preferred embodiment of the present invention is shown generally at 48. The third preferred embodiment 48 includes an instrument pointer 16 with either one or two reflective surfaces 30, 46 as shown in the first and second embodiments 10, 44. However, the third preferred embodiment 48 further includes a reflector 50 surrounding the gage motor shaft 14 which is adapted to reflect the light from the light sources 24 upward into the instrument pointer 16.

Preferably, the reflector 50 is conical in shape, whereby light from the light sources 24 can be collected in the horizontal plane from any angular position around the gage motor shaft 14 and reflected upward into the light collection portion 28 of the instrument pointer 16.

The third preferred embodiment 48 further includes a light collector 52 surrounding the reflector 50 which is adapted to focus the light from the light sources 24 onto the reflector 50. The light collector 52 is made from a clear material suitable for transmitting light therethrough, and includes a plurality of lenses 54. One of the lenses 54 are aligned with each of the light sources 24 and adapted to focus light from the light sources 24 onto the reflector.

Preferably, the lenses 54 are astigmatic lenses. Referring to FIG. 5, in the horizontal plane said lenses 54 focus the light into converging beams 55, whereby said beams 55 converge onto an axis coaxial with the gage motor shaft 14. Referring to FIG. 4, in the vertical plane the lenses 54 focus the light into parallel beams 57. Preferably, the light sources 24 are positioned around the gage motor shaft 14 axially below the instrument pointer 16 and radially outward of the light collector 52, whereby the light collector 52 focuses the light onto the reflector 50 and the reflector 50 reflects the light upward into the instrument pointer 16.

Similarly to the first and second embodiments 10, 44, the third preferred embodiment 48 can use any number of light sources 24, wherein the size of the light sources 24 and the area available to mount the light sources 24 are the limiting factors. However, the third preferred embodiment 48 is not limited in that the light sources 24 must be mounted within an area beneath the light collection portion 28 of the instrument pointer 16 like the first and second embodiments 10, 44. Since the light sources 24 in the third preferred embodiment 48 provide light to the light collector 52 in the horizontal plane, the light sources 24 can be placed radially around the gage motor shaft 14 at any reasonable distance from the gage motor shaft 14.

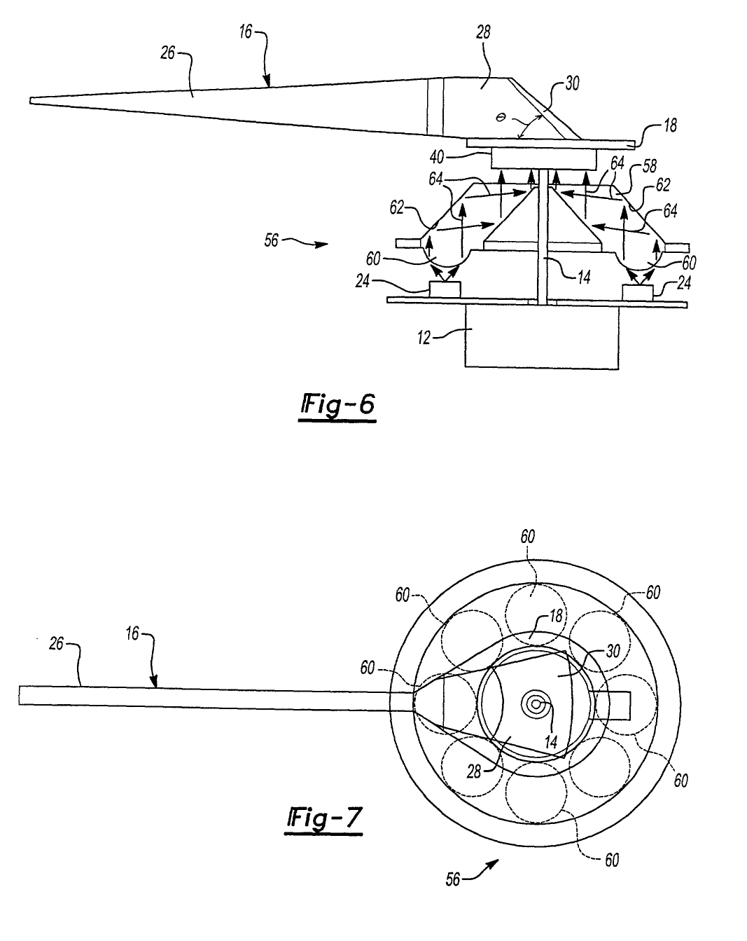

Referring to FIGS. 6 and 7, a fourth preferred embodiment of the present invention is shown generally at 56. The fourth preferred embodiment includes a light collector 58 with lenses 60. Preferably, the lenses are spherical or hyperbolic, however, other suitable lenses could be used depending upon the application. The lenses 60 focus light into parallel beams. In the fourth preferred embodiment, the light collector 58 includes an internally reflective surface 62. Preferably, the internally reflective surface 62 is conical in shape. The internally reflective surface 62 could be achieved by refraction from the internal side of the light collector 58, however, the light collector 58 could also include a mirrored surface mounted thereon to provide a reflective surface.

The light sources 24 of the fourth preferred embodiment are positioned radially around said gage motor shaft 14, however, rather that being radially outward of the light collector 52 as in the third preferred embodiment, the light sources 24 of the fourth preferred embodiment are axially below the light collector 58, and the lenses 60 are located on the bottom of the light collector 58. The light sources 24 provide light to the lenses 60, which focus the light into parallel beams 64 that travel upward until they hit the internally reflective surface 62 of the light collector 58. The conical shape of the internally reflective surface 62 focuses the light onto an axis coaxial with the gage motor shaft 14 so that the light is reflected from the reflector 50 upward into the light collecting portion 28 of the instrument pointer 16.

Because the internally reflective surface 62 of the light collector 58 is conically shaped, the lenses 60 can be spaced radially around the light collector 58 to collect light from light sources 24 spaced radially at any angular position around the gage motor shaft 14.

The foregoing discussion discloses and describes four preferred embodiments of the invention. One skilled in the art will readily recognize from such discussion, and from the accompanying drawings and claims, that changes and modifications can be made to the invention without departing from the true spirit and fair scope of the invention as defined in the following claims. The invention has been described in an illustrative manner, and it is to be understood that the terminology which has been used is intended to be in the nature of words of description rather than of limitation.

What is claimed is:

1. An instrument pointer illuminating apparatus comprising:
a gage motor with a gage motor shaft extending therefrom;
an instrument pointer mounted on said gage motor shaft;
a plurality of light sources positioned radially around said gage motor shaft adapted to supply light upward into said instrument pointer;
said instrument pointer including a needle portion and a light reflecting portion, said light reflecting portion being flared outward from said needle portion, said light reflecting portion having a first reflective surface presenting an internally reflective surface adapted to reflect light received from said light sources outward into said needle portion.

2. The instrument pointer illumination apparatus of claim 1 wherein said instrument pointer further includes a hub with a top surface and a bottom surface, said instrument pointer being mounted to said top surface.

3. The instrument pointer illumination apparatus of claim 2 wherein said light reflecting portion is adapted to cover substantially all of said top surface of said hub to reflect substantially all of the light from said light sources outward into said needle portion at any angular position of said needle portion.

4. The instrument pointer illumination apparatus of claim 3 wherein said light reflective portion is flared outward from said needle portion across said hub.

5. The instrument pointer illuminating apparatus of claim 1 wherein said light reflecting portion includes a plurality of reflective surfaces adapted to reflect light received through said hub portion outward into said needle portion.

6. The instrument pointer illuminating apparatus of claim 5 wherein each of said reflective surfaces presents and internally reflective surface adapted to reflect light from said light sources outward into said needle portion.

7. The instrument pointer illuminating apparatus of claim 5 wherein said plurality of reflective surfaces are matched to each other such that light is reflected from each of said reflective surfaces outward into said needle portion.

8. The instrument pointer illuminating apparatus of claim 1 wherein said needle portion includes a top surface and a bottom surface, said top surface being coated with a top diffusing material adapted to diffuse light outward through said top surface, and said bottom surface being coated with a material adapted to internally reflect within said needle portion substantially all of the light which hits said bottom surface.

9. The instrument pointer illuminating apparatus of claim 1 further including a light guide mounted to said bottom surface of said hub portion adapted to propagate light from said light sources upward into said pointer.

10. The instrument pointer illuminating apparatus of claim 1 wherein said light sources are positioned radially around said gage motor shaft and axially below said pointer and are adapted to supply light upward into said light collecting portion.

11. The instrument pointer illuminating apparatus of claim 1 wherein each of said light sources includes a lens for focusing the light produced by said light source.

12. The instrument pointer illuminating apparatus of claim 1 further including a reflector surrounding said gage motor shaft adapted to reflect light from said light sources upward into said pointer.

13. The instrument pointer illuminating apparatus of claim 12 further including a light collector surrounding said reflector adapted to focus light from said light sources onto said reflector.

14. The instrument pointer illuminating apparatus of claim 13 wherein said light collector includes a plurality of lenses, one of said plurality of lenses being aligned with each of said light sources and adapted to focus light from said light sources onto said reflector.

15. The instrument pointer illuminating apparatus of claim 14 wherein said reflector is conical in shape, whereby light from said light sources can be collected from any angular position around said gage motor shaft and reflected upward into said light collection portion of said instrument pointer.

16. The instrument pointer illuminating apparatus of claim 15 wherein said lenses of said light collector are astigmatic lenses, whereby in the horizontal plane said lenses focus the light onto an axis coaxial with said gage motor shaft, and in the vertical plane said lenses focus the light into parallel beams.

17. The instrument pointer illuminating apparatus of claim 16 wherein said light sources are positioned around said gage motor shaft axially below said instrument pointer and radially outward of said light collector, whereby said light collector focuses light onto said reflector and said reflector reflects the light upward into said instrument pointer.

18. The instrument pointer illumination apparatus of claim 15 wherein said lenses of said light collector focus the light collected by said lenses into parallel beams.

19. The instrument pointer illumination apparatus of claim 18 wherein said light sources are positioned around said gage motor shaft and axially below said light collector and said light collector includes an internally reflective surface, whereby said lenses concentrate the light onto said internally reflective surface and said internally reflective surface reflects the light onto said reflector and said reflector reflects the light upward into said light collecting portion of said instrument pointer.

20. The instrument pointer illumination apparatus of claim 19 wherein said internally reflective surface is conical in shape so that light from any of said light sources at any angular position around said gage motor shaft will be reflected onto said reflector and upward into said light collecting portion of said instrument pointer.

21. The instrument pointer illumination apparatus of claim 1 wherein said light sources are light emitting diodes.
